(19) United States
(12) Patent Application Publication
(10) Pub. No.: US 2011/0188914 A1
(43) Pub. Date: Aug. 4, 2011

(54) PRINTING APPARATUS

(75) Inventor: Ryo Imai, Saitama-shi (JP)

(73) Assignee: FUJIFILM Corporation, Tokyo (JP)

(21) Appl. No.: 12/962,520

(22) Filed: Dec. 7, 2010

(30) Foreign Application Priority Data
Jan. 29, 2010 (JP) JP2010-019000

(51) Int. Cl. B41J 33/02

(52) U.S. Cl. 400/223

(57) ABSTRACT

A printing apparatus configured to transfer ink on a color ink ribbon to a print medium to thereby create a color photographic print, includes: a ribbon switching rotary mechanism into which a plurality of the color ink ribbons are loaded, and the mechanism configured to set a desired one of the color ink ribbons to a photographic printing position; a ribbon detection device configured to detect the color ink ribbons loaded into the mechanism, the ribbon detection device detecting whether the desired and set color ink ribbon is a single-color ribbon or a multi-color ribbon; a ribbon head-detecting device configured to perform head-detecting of the multi-color ribbon in a case where the multi-color ribbon is loaded into the mechanism; and a control device configured to control the mechanism and the ribbon head-detecting device so as to suit each of a time of photographic printing using the single-color ribbon and a time of photographic printing using the multi-color ribbon.

### BACKGROUND OF THE INVENTION

1. Field of the Invention

The presently disclosed subject matter relates to a printing apparatus, and more particularly, to a printing apparatus which transfers ink on a color ink ribbon to a print medium to thereby create a color photographic print.

2. Description of the Related Art

Conventionally, a printing apparatus in which a plurality of types of ribbon cassettes can be replaced with each other has been proposed (Japanese Patent Application Laid-Open No. 2005-119318).

Japanese Patent Application Laid-Open No. 2005-119318 describes the following two systems. That is, in one system, a ribbon cassette which houses a single-color ink ribbon (single-color ribbon) is used, and the ribbon cassette is replaced for each color, to thereby perform printing. In the other system, a ribbon cassette which houses a multi-color ink ribbon (multi-color ribbon) to which three primary colors of yellow/magenta/cyan or the like are alternately applied is used, and the three primary colors for respective colors are superimposed on each other to thereby reproduce the respective colors without replacing the ribbon cassette.

In addition, there has been proposed a color printer including a holding member which rotatably holds four sets of single-color ribbons of Y (yellow), M (magenta), C (cyan), and B (black), in which the holding member is rotated to select and move a desired single-color ribbon to a recording position.

### SUMMARY OF THE INVENTION

The printing apparatus described in Japanese Patent Application Laid-Open No. 2005-119318 is a label printer which creates a tape-like label, and thus is not intended to create a photographic print. In addition, the number of the ribbon cassette set to the apparatus is one. Accordingly, in this printing apparatus, in the case of the printing system using the ribbon cassette which houses the multi-color ribbon, the three primary colors for respective colors are superimposed on each other, to thereby make it possible to reproduce a desired color without replacing the ribbon cassette. On the other hand, in the case of the printing system using the ribbon cassette which houses the single-color ribbon, it is necessary to set a ribbon cassette corresponding to a desired color. In addition, it is conceivable to perform printing by superimposing colors of different single-color ribbons on each other. In this case, it is necessary to replace the ribbon cassette for each superimposition of the color of the ink ribbon, which leads to a problem that the operation is cumbersome and complicated.

On the other hand, in the color printer described in Japanese Patent Application Laid-Open No. 11-170583, the holding member which rotatably holds the four sets of the single-color ribbons is rotated, whereby switching of the single-color ribbons can be easily performed. However, in the configuration of this color printer, the multi-color ribbon cannot be used, which leads to a problem that the single-color ribbon and the multi-color ribbon cannot be selectively used depending on the intended purpose.

The presently disclosed subject matter has been made in view of the above-mentioned circumstances, and therefore has an object to provide a printing apparatus in which photographic printing using a single-color ribbon and photographic printing using a multi-color ribbon can be selectively used depending on the demand and intended purpose of a user and a color photographic print can be efficiently created by the automation of ribbon switching.

In order to achieve the above-mentioned object, a first aspect of the presently disclosed subject matter provides a printing apparatus configured to transfer ink on a color ink ribbon to a print medium to thereby create a color photographic print, including: a ribbon switching rotary mechanism into which a plurality of the color ink ribbons are loaded, and the ribbon switching rotary mechanism configured to set a desired one of the color ink ribbons to a photographic printing position; a ribbon detection device configured to detect the color ink ribbons loaded into the ribbon switching rotary mechanism, the ribbon detection device detecting whether the desired color ink ribbon set to the photographic printing position is a single-color ribbon or a multi-color ribbon; a ribbon head-detecting device configured to perform head-detecting (cueing) of the multi-color ribbon in a case where the multi-color ribbon is loaded into the ribbon switching rotary mechanism; and a control device configured to control the ribbon switching rotary mechanism and the ribbon head-detecting device so as to suit each of a time of photographic printing using the single-color ribbon and a time of photographic printing using the multi-color ribbon.

That is, at the time of the photographic printing using the single-color ribbon, photographic printing is performed while the ribbons are automatically switched by the ribbon switching rotary mechanism, so that the color photographic print can be created. On the other hand, at the time of the photographic printing using the multi-color ribbon, the head-detecting of the multi-color ribbon is performed by the ribbon head-detecting device, so that the color photographic print can be created. Accordingly, it is possible to selectively use the photographic printing using the single-color ribbon and the photographic printing using the multi-color ribbon.

The advantages of the use of the single-color ribbon are that the single-color ribbon is less expensive than the multi-color ribbon, and a waste of the ribbon caused by the head-detecting of the ribbon and the like does not occur. The disadvantages thereof are that, because the ink ribbons are replaced for all colors at the same time and thus the number of ribbons are large (for example, in the case of one multi-color ribbon of Y, M, and C, three single-color ribbons are necessary, and in the case of one multi-color ribbon of Y, M, C, and W, four single-color ribbons are necessary), the ribbon replacement work is cumbersome, and there is fear of an erroneous operation such as setting a ribbon of incorrect color by mistake. Accordingly, it is conceivable to perform the photographic printing using the single-color ribbon in the case where the number of pages for photographic printing at a time is large, and to perform the photographic printing using the multi-color ribbon in the case where the number of pages for photographic printing at a time is small.

A second aspect of the presently disclosed subject matter provides a printing apparatus according to the first aspect, wherein: the ribbon head-detecting device includes: a ribbon head-detection sensor which detects a color boundary position between respective color ink ribbons of the multi-color ribbon as well as colors of the respective color ink ribbons; and a ribbon feeding device configured to feed the color ink ribbons loaded into the ribbon switching rotary mechanism; and the ribbon feeding device is controlled so that head positions of the respective color ink ribbons of the multi-color ribbon come to the photographic printing position, at a start of the photographic printing for each color using the multi-color ribbon on a basis of a detection output of the ribbon head-detection sensor.

A third aspect of the presently disclosed subject matter provides a printing apparatus according to the second aspect, wherein the ribbon head-detection sensor detects the color of the multi-color ribbon or reads a ribbon head-detection marker which is printed at the color boundary position between the respective color ink ribbons of the multi-color ribbon.

That is, in the case where a sensor which detects the color of the multi-color ribbon is used as the ribbon head-detection sensor, it is possible to detect the colors of the respective color ink ribbons of the multi-color ribbon, and also possible to detect the color boundary position between the respective color ink ribbons by detecting a change in color. In addition, in the case where the ribbon head-detection marker is provided at the color boundary position between the respective color ink ribbons of the multi-color ribbon, a sensor which reads the ribbon head-detection marker can be used as the ribbon head-detection sensor.

A fourth aspect of the presently disclosed subject matter provides a printing apparatus according to any one of the first to third aspects, wherein the control device stops the ribbon head-detection sensor at the time of the photographic printing using the single-color ribbon.

A fifth aspect of the presently disclosed subject matter provides a printing apparatus according to any one of the first to fourth aspects, further including a ribbon presence/absence detection device configured to detect presence/absence of the color ink ribbons loaded into the ribbon switching rotary mechanism, wherein when the ribbon detection device detects that a plurality of the multi-color ribbons are loaded into the ribbon switching rotary mechanism and when the ribbon presence/absence detection device detects that the multi-color ribbon set to the photographic printing position is finished up, the control device controls the ribbon switching rotary mechanism so that another one of the multi-color ribbons is set to the photographic printing position.

This makes it possible to effectively use the plurality of multi-color ribbons loaded into the ribbon switching rotary mechanism.

A sixth aspect of the presently disclosed subject matter provides a printing apparatus according to any one of the first to fifth aspects, further including an input device through which a print size of the print medium is inputted, wherein: in a case where the plurality of multi-color ribbons having ribbon widths different from each other are loaded into the ribbon switching rotary mechanism, the ribbon detection device detects the widths of the respective multi-color ribbons; and in the case where the plurality of multi-color ribbons having the ribbon widths different from each other are loaded into the ribbon switching rotary mechanism, the control device controls the ribbon switching rotary mechanism so that the multi-color ribbon corresponding to the print size inputted through the input device is set to the photographic printing position.

This makes it possible to use the multi-color ribbon having the ribbon width corresponding to the print size of the print medium, and thus possible to efficiently use the multi-color ribbon.

A seventh aspect of the presently disclosed subject matter provides a printing apparatus according to any one of the first to sixth aspects, further including a print instruction input device through which a print instruction to perform any one of the photographic printing using the single-color ribbon and the photographic printing using the multi-color ribbon is inputted in a case where the single-color ribbon and the multi-color ribbon are loaded into the ribbon switching rotary mechanism, wherein the control device controls the ribbon switching rotary mechanism and the ribbon head-detecting device in response to the print instruction inputted through the print instruction input device.

This makes it possible to easily make switching between the photographic printing using the single-color ribbon and the photographic printing using the multi-color ribbon.

An eighth aspect of the presently disclosed subject matter provides a printing apparatus according to any one of the first to seventh aspects, wherein: a winding core of the color ink ribbon has attached thereto information indicating whether this color ink ribbon is the single-color ribbon or the multi-color ribbon and, in a case of the single-color ribbon, information indicating a color thereof; and the ribbon detection device reads the information from the winding core of the color ink ribbon.

A ninth aspect of the presently disclosed subject matter provides a printing apparatus according to any one of the first to eighth aspects, wherein: the winding core of the color ink ribbon has a wireless tag embedded therein, the wireless tag storing therein the information indicating whether this color ink ribbon is the single-color ribbon or the multi-color ribbon and, in the case of the single-color ribbon, the information indicating the color thereof; and the ribbon detection device is a wireless tag reader configured to read the information from the wireless tag.

A tenth aspect of the presently disclosed subject matter provides a printing apparatus according to any one of the first to eighth aspects, wherein: the winding core of the color ink ribbon has, recorded thereon as a bar code, the information indicating whether this color ink ribbon is the single-color ribbon or the multi-color ribbon and, in the case of the single-color ribbon, the information indicating the color thereof; and the ribbon detection device is a bar code reader configured to read the bar code.

An eleventh aspect of the presently disclosed subject matter provides a printing apparatus according to any one of the first to tenth aspects, wherein: the print medium is a transparent lenticular sheet having a surface on which lenticular lenses are formed; the printing apparatus transfers an image receiving layer to a rear surface of the lenticular sheet, and then sequentially transfers inks of yellow, magenta, cyan to thereby create the color photographic print for stereoscopic view; and four or five ribbons can be loaded into the ribbon switching rotary mechanism.

According to the presently disclosed subject matter, at the time of the photographic printing using the single-color ribbon, photographic printing is performed while the ribbons are automatically switched by the ribbon switching rotary mechanism, so that the color photographic print can be created. On the other hand, at the time of the photographic printing using the multi-color ribbon, the head-detecting of the multi-color ribbon is performed by the ribbon head-detecting device, so that the color photographic print can be created. Accordingly, it is possible to selectively use the photographic printing using the single-color ribbon and the photographic printing using the multi-color ribbon depending on the demand and intended purpose of a user, and also possible to efficiently create the color photographic print by the automation of ribbon switching.

### BRIEF DESCRIPTION OF THE DRAWINGS

FIG. 1 is a see-through view schematically illustrating an inside of a printing apparatus when a photographic print medium is supplied thereto;

FIG. 2 is another see-through view schematically illustrating the inside of the printing apparatus when the photographic print medium is supplied thereto;

FIG. 3 is a front perspective view illustrating a sheet storage unit;

FIG. 4 is a perspective view illustrating a sheet feeding cassette into which lenticular sheets are inserted;

FIG. 5 is a perspective view illustrating the sheet feeding cassette whose cassette cover is closed;

FIG. 6 is a schematic view illustrating a side surface of the sheet storage unit;

FIG. 7 is an enlarged view illustrating a main part of the sheet storage unit;

FIG. 8A is an enlarged view illustrating a main part of a photographic printing unit;

FIG. 8B is another enlarged view illustrating the main part of the photographic printing unit;

FIG. 9A is still another enlarged view illustrating the main part of the photographic printing unit;

FIG. 9B is still another enlarged view illustrating the main part of the photographic printing unit;

FIG. 10 is a plan view illustrating a schematic structure of a clamper and a clamper transport unit;

FIG. 11 is a perspective view illustrating an ink ribbon;

FIG. 12A is a plan view illustrating a multi-color ribbon;

FIG. 12B is a plan view illustrating another multi-color ribbon;

FIG. 13 is a schematic view illustrating a ribbon switching rotary mechanism;

FIG. 14 is a block diagram illustrating a configuration of a main part of the printing apparatus;

FIG. 15 is a flow chart illustrating a photographic printing process using a single-color ribbon; and

FIG. 16 is a flow chart illustrating a photographic printing process using the multi-color ribbon.

### DETAILED DESCRIPTION OF THE PREFERRED EMBODIMENTS

Hereinafter, a printing apparatus according to an embodiment of the presently disclosed subject matter is described with reference to the accompanying drawings.

### [Overall Structure of Printing Apparatus]

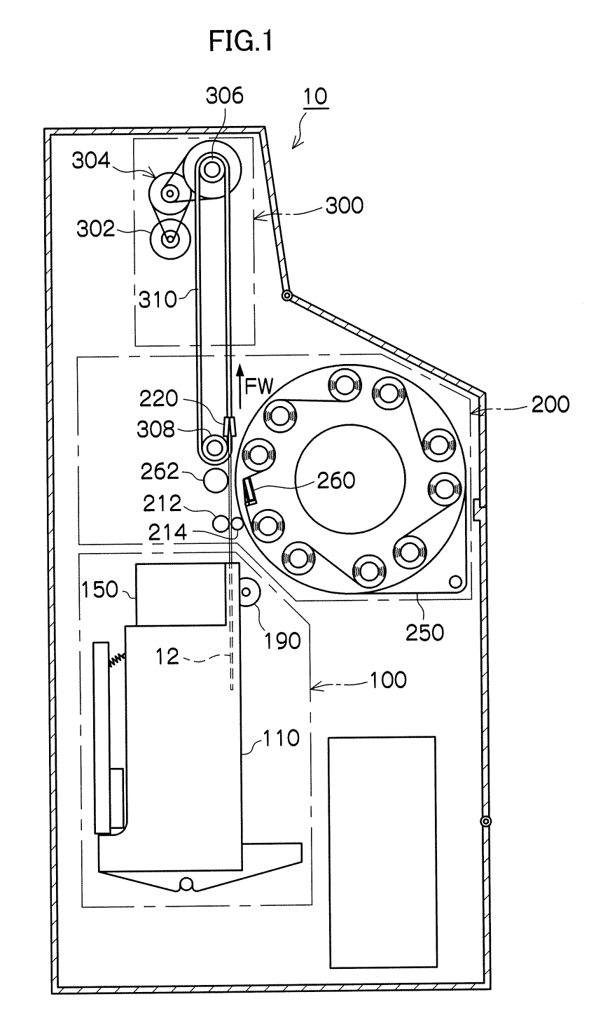

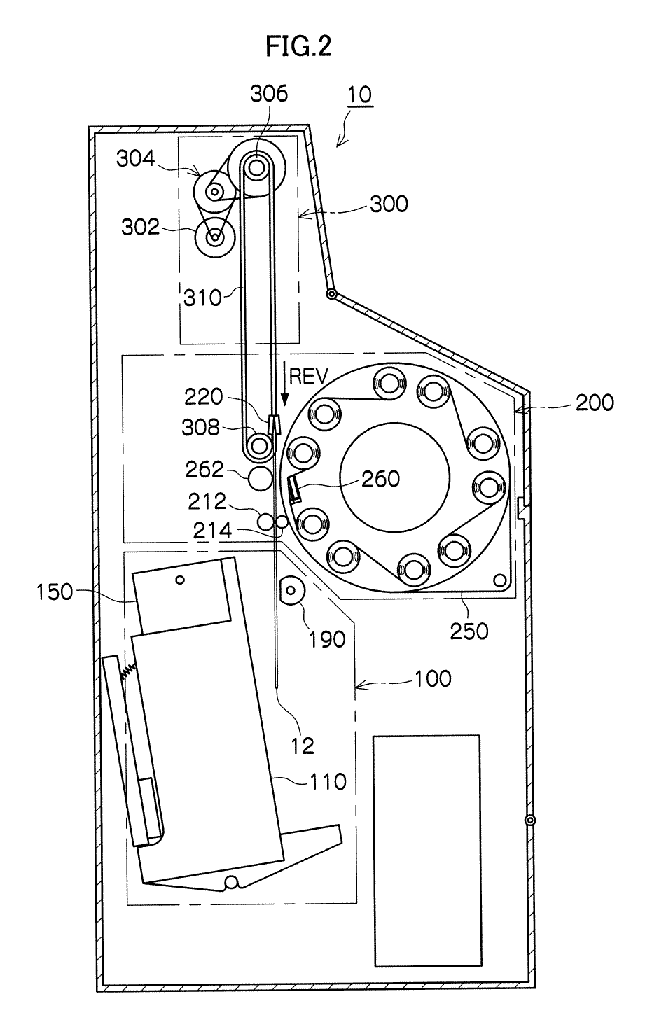

FIG. 1 and FIG. 2 are see-through views each schematically illustrating an inside of the printing apparatus according to the embodiment of the presently disclosed subject matter. FIG. 1 illustrates a state where a lenticular sheet is supplied from a sheet feeding cassette. FIG. 2 illustrates a state where a sheet return operation and the like are performed after photographic printing.

As illustrated in FIG. 1 and FIG. 2, a printing apparatus 10 is intended to create a photographic print of a three-dimensional image (hereinafter, referred to as “3D print”), and is a vertically-installed 3D printer which performs photographic printing while transporting in a vertical direction a photographic print medium (hereinafter, referred to as “lenticular sheet”) 12 which is made of a transparent resin and has a surface on which a so-called lenticular lens including a group of semicircular (hog-backed) lenses is formed, to thereby create a 3D print. Resins such as PET (polyethylene terephthalate) and PMMA (Poly(methyl methacrylate), acrylic resin) are adopted as a material of the lenticular sheet 12.

The printing apparatus 10 includes a sheet storage unit 100, a photographic printing unit 200, and an idle feeding unit 300.

In addition, the printing apparatus 10 is a sublimation-type (dye-sublimation) printer which uses ink ribbons of R (image receiving layer), Y (yellow), M (magenta), C (cyan), and W (white), and repeatedly performs an upward motion (at the time of photographic printing) and a downward motion (at the time of reverse feeding to a photographic printing start position) for each photographic printing color. A transport path of the lenticular sheet 12 is configured as the same straight path for both of the upward motion and the downward motion.

### <Sheet Storage Unit>

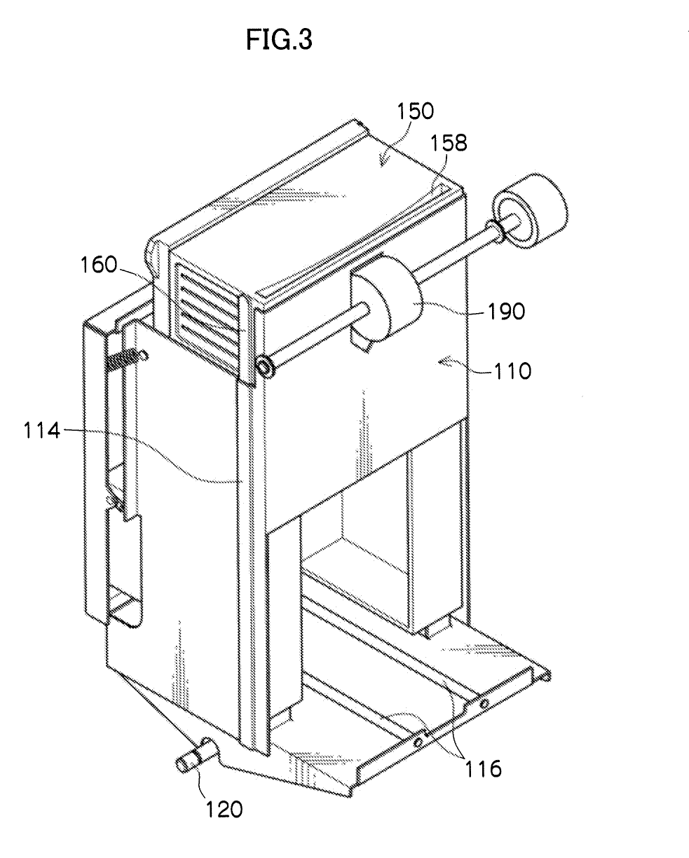

FIG. 3 is a perspective view illustrating a detailed structure of the sheet storage unit 100.

The sheet storage unit 100 includes a sheet storage main body 110 and a sheet feeding cassette 150, and the sheet feeding cassette 150 is detachably attached to the sheet storage main body 110.

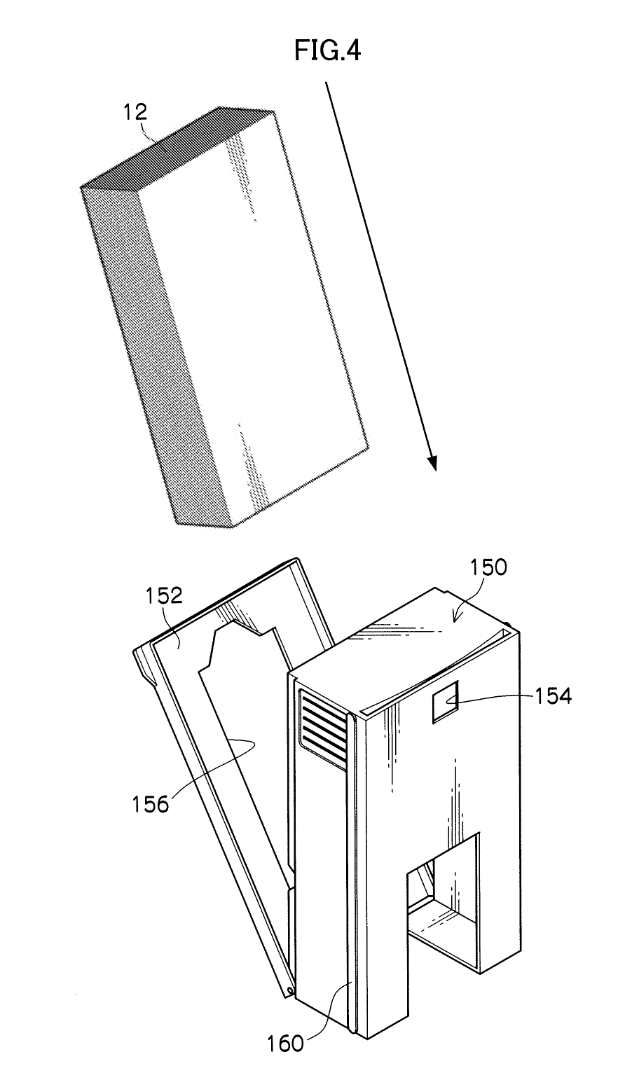

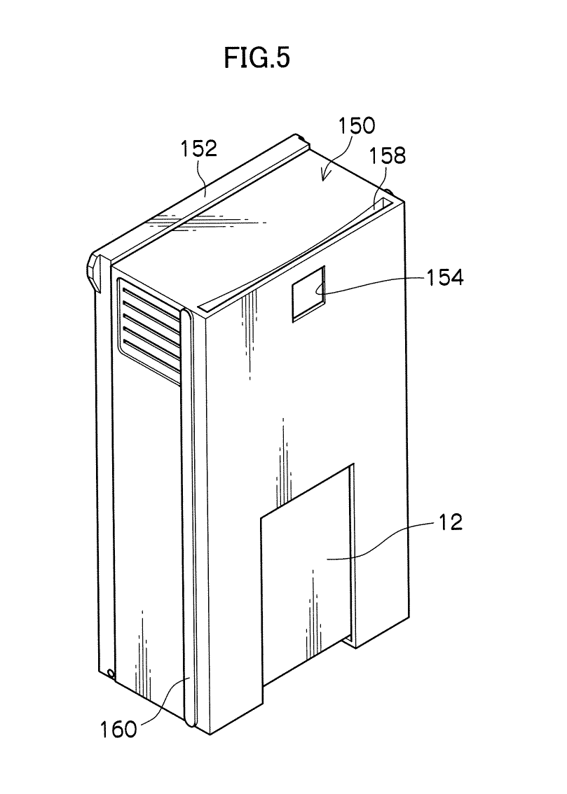

FIG. 4 and FIG. 5 are perspective views each illustrating the sheet feeding cassette 150. FIG. 4 illustrates a state where a cassette cover 152 of the sheet feeding cassette 150 is opened, and then about 100 to 200 stacked lenticular sheets 12 are inserted into the cassette. FIG. 5 illustrates a state where the cassette cover 152 is closed after the lenticular sheets 12 are inserted into the cassette.

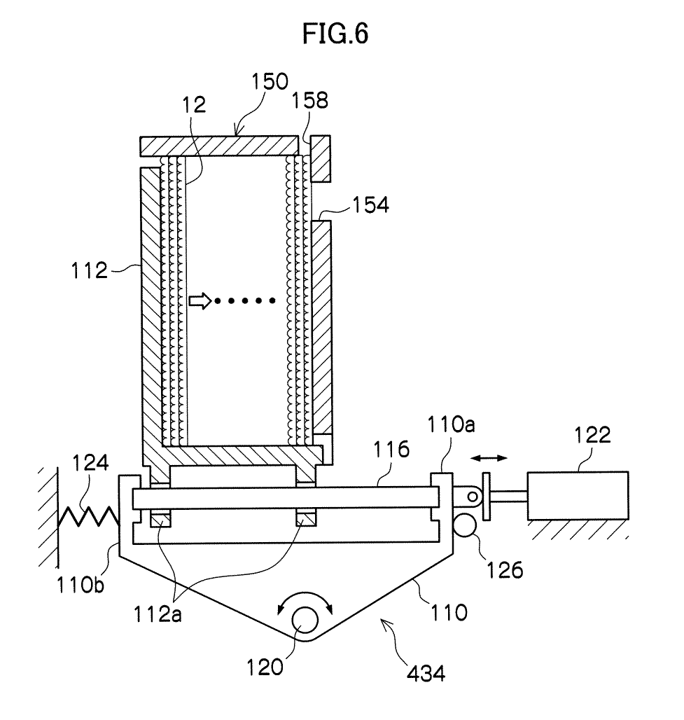

An opening 154 into which a feed roller 190 (see FIG. 3) is inserted is formed in a front surface of the sheet feeding cassette 150. On the other hand, a pressure plate opening 156 into which an L-shaped pressure plate 112 (see FIG. 6) is inserted is formed in the cassette cover 152 in a back surface of the sheet feeding cassette 150.

In addition, an outlet 158 for outputting one lenticular sheet 12 from the cassette is formed in an upper surface of the sheet feeding cassette 150, and a ridge 160 is formed in the vertical direction in a side surface of the sheet feeding cassette 150. The ridge 160 of the sheet feeding cassette 150 is engaged with a groove 114 which is formed in a side surface of the sheet storage main body 110, whereby the sheet feeding cassette 150 is positioned at a predetermined position in the sheet storage main body 110.

FIG. 6 is a schematic view illustrating a side surface of the sheet storage unit 100.

When the sheet feeding cassette 150 is inserted into the sheet storage main body 110, the lenticular sheets 12 stored in the sheet feeding cassette 150 are placed on the L-shaped pressure plate 112 of the sheet storage main body 110.

The pressure plate 112 is supported by two guide shafts 116 (see FIG. 3) at a single degree of freedom in a direction from the front surface to the back surface (in a horizontal direction in FIG. 6), and can be moved by a pressure plate drive mechanism including a motor (not illustrated).

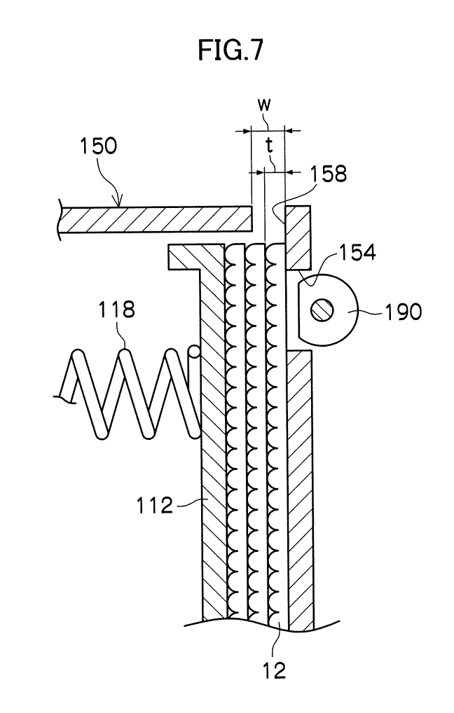

In addition, as illustrated in FIG. 7, the pressure plate 112 presses the lenticular sheets 12 within the cassette by means of an elastic member 118, and a position of the pressure plate 112 is controlled so that the pressure plate 112 presses the lenticular sheets 12 always at a constant pressure.

The sheet storage main body 110 can be rocked by a cassette rocking mechanism 434 illustrated in FIG. 6. The cassette rocking mechanism 434 includes a plunger 122, an urging spring 124, and a stopper 126, and the sheet storage main body 110 is provided so as to be rockable by a rotation shaft 120 located at a bottom part.

When the lenticular sheet 12 is to be supplied from the sheet feeding cassette 150 as illustrated in FIG. 1, power supply to the plunger 122 is turned off. As a result, the sheet storage main body 110 is turned to an abutment position of the stopper 126 by an urging force of the urging spring 124, and the sheet feeding cassette 150 housed in the sheet storage main body 110 is held at a vertical position.

On the other hand, when the lenticular sheet 12 is outputted from the sheet feeding cassette 150 and then photographic printing using the first ink ribbon is finished, the power supply to the plunger 122 is turned on. As a result, the sheet storage main body 110 is turned (rotated, tilted) in a counterclockwise direction in FIG. 6 against the urging force of the urging spring 124.

FIG. 2 illustrates the state where the sheet storage main body 110 is tilted by the plunger 122. The lenticular sheet 12 is returned to the photographic printing start position for photographic printing using the next ink ribbon, but the interference of the lenticular sheet 12 with the sheet feeding cassette 150 can be avoided by tilting the sheet storage main body 110 (sheet feeding cassette 150).

In this way, the lenticular sheet 12 can be transported along the straight path for both of the photographic printing operation and the returning operation of the lenticular sheet 12, and the transport path of the lenticular sheet 12 is shortened (the apparatus is downsized).

As illustrated in FIG. 3 and FIG. 7, when the feed roller 190 is driven, the lenticular sheet 12 which abuts against the driven feed roller 190 is fed from the outlet 158 of the sheet feeding cassette 150.

Here, a width W of the outlet 158 is formed so as to be larger than a sheet thickness t of one lenticular sheet 12 and smaller than a sheet thickness 2t of two lenticular sheets 12, and this enables only one lenticular sheet 12 to be fed from the outlet 158.

In addition, the feed roller 190 has a D shape (D cut) in cross section, and is controlled to stop when the D cut reaches a position at which the D cut is opposed to the lenticular sheet 12. With this configuration, the lenticular sheet 12 is fed by a given amount from the sheet feeding cassette 150, and at this time, the feed roller 190 does not abut against the lenticular sheet 12 (a frictional force of the feed roller 190 does not act thereon).

### <Photographic Printing Unit>

As illustrated in FIG. 1 and FIG. 2, the photographic printing unit 200 includes: a sheet transport mechanism 431 which transports the lenticular sheet 12 at the time of photographic printing and the like; a ribbon switching rotary mechanism 250 into which the ink ribbons of R, Y, M, C, and W are loaded; and a thermal head 260.

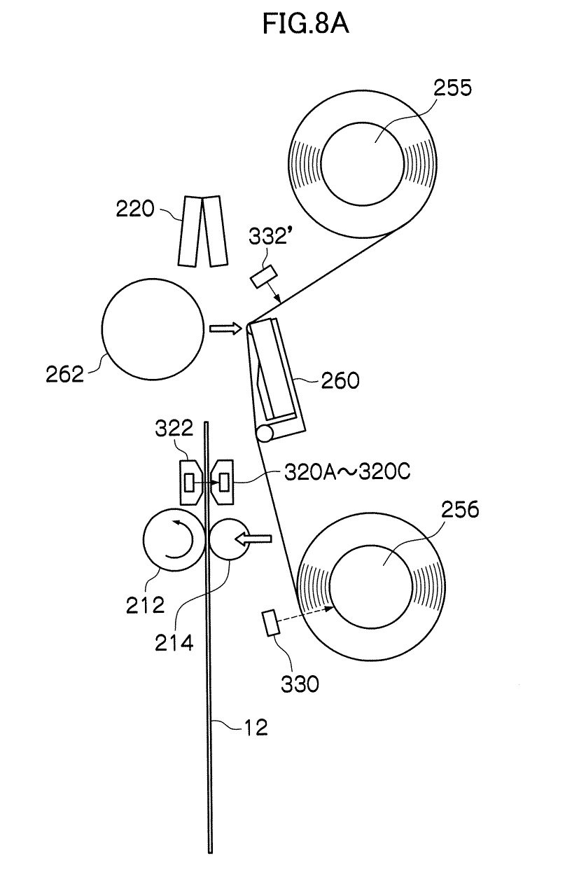

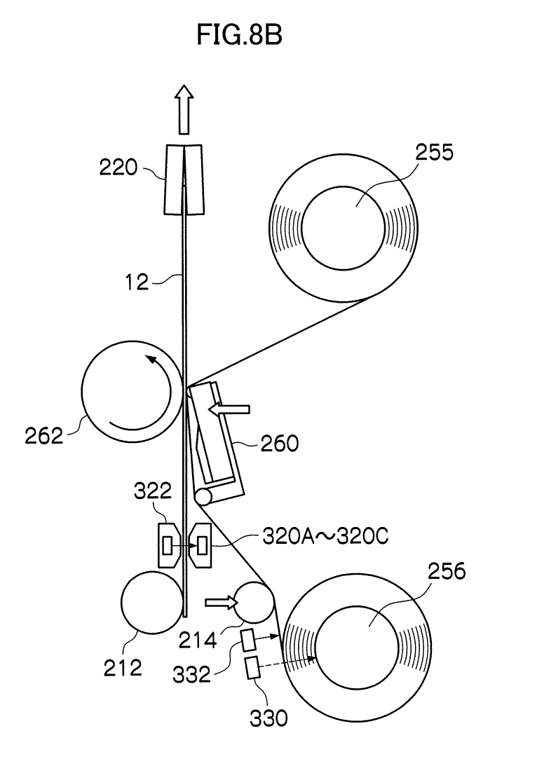

FIG. 8A and FIG. 8B are enlarged views each illustrating a main part of the photographic printing unit 200.

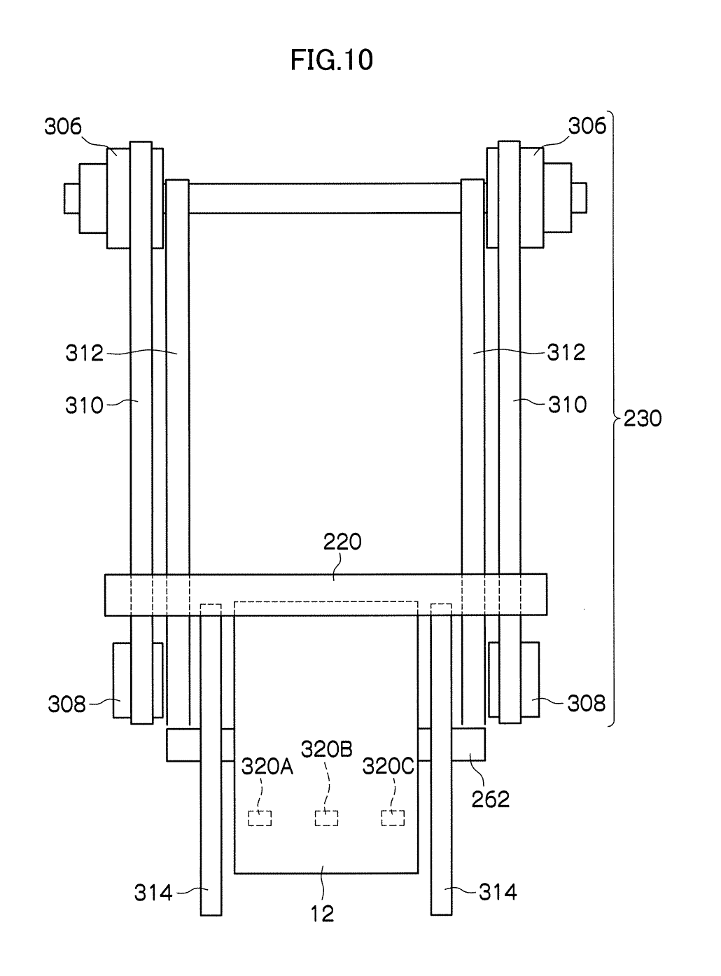

The sheet transport mechanism 431 includes the feed roller 190, a transport roller 212, a capstan 214, a clamper 220, and a clamper transport unit 230 (see FIG. 10) which moves the clamper 220.

A leading end of the lenticular sheet 12 which is fed by the feed roller 190 by a given amount from the sheet feeding cassette 150 reaches a position of the transport roller 212. Here, the capstan 214 is pressed against the transport roller 212 via the lenticular sheet 12, and the transport roller 212 is driven, whereby the lenticular sheet 12 can be transported (see FIG. 8A).

The transport of the lenticular sheet 12 by the transport roller 212 and the capstan 214 is continued until the leading end of the lenticular sheet 12 reaches the clamper 220 which stands by at a predetermined lowermost position. It should be noted that a pair of clamping members of the clamper 220 is always urged in a closing direction by a spring, but in the above-mentioned stand-by state, the clamper 220 stands by with the pair of clamping members being opened against an urging force of the spring by a cam or the like.

When the leading end of the lenticular sheet 12 reaches the clamper 220, the leading end of the lenticular sheet 12 is nipped by the clamper 220, and the capstan 214 is retreated from the transport roller 212. After that, the lenticular sheet 12 is transported (moved upward or downward) by the clamper transport unit 230 together with the clamper 220 (see FIG. 8B).

FIG. 10 is a plan view illustrating a schematic structure of the clamper 220 and the clamper transport unit 230.

A pair of drive pulleys 306, which is driven by a drive motor 302 via a deceleration mechanism 304, is provided at an upper end of the idle feeding unit 300 illustrated in FIG. 1, and a pair of driven pulleys 308 is provided in the vicinity of a platen roller 262.

Drive belts 310 are wound around between the drive pulleys 306 and the driven pulleys 308, and as illustrated in FIG. 10, the clamper 220 is fixed by bolts (not illustrated) between the drive belts 310.

In addition, guide rails 312 which guide the clamper 220 in the vertical direction along the drive belts 310 are provided. Further, resin guides 314 which guide the lenticular sheet 12 toward the clamper 220 which stands by at the predetermined lowermost position are provided. It should be noted that rubber guides may be used instead of the resin guides 314.

An interval between a pair of the resin guides 314 is set to be larger by a predetermined clearance than a width of the lenticular sheet 12, and the resin guides 314 guide the lenticular sheet 12 along the vertical direction.

In addition, three photosensors 320A, 320B, and 320C are provided parallel to the platen roller 262 on an entrance side of the platen roller 262, and a light-emitting diode (LED) 322 (see FIG. 8A and FIG. 8B) is provided at a position at which the LED 322 is opposed to the photosensors 320A, 320B, and 320C with the transport path of the lenticular sheet 12 being sandwiched therebetween.

Detection signals of the lenticular sheet 12 which are detected by the photosensors 320A, 320B, and 320C become largest when an optical axis of each photosensor matches with the center of a lens of the lenticular sheet 12, and become smallest when the optical axis thereof is located in a valley between lenses. Accordingly, it is possible to detect the inclination (azimuth angle) of the lenticular sheet 12 on the basis of the detection signals of the three photosensors 320A, 320B, and 320C.

Azimuth adjustment (adjustment for making the azimuth angle zero) of the lenticular sheet 12 is performed in the following manner. That is, after the leading end of the lenticular sheet 12 is nipped by the clamper 220, the pair of right and left drive pulleys 306 are driven independently of each other while the detection signals of the three photosensors 320A, 320B, and 320C are monitored, and then the clamper 220 is slightly inclined by an amount corresponding to the azimuth adjustment.

After the azimuth adjustment is performed as described above, the lenticular sheet 12 is transported to the photographic printing start position by moving the clamper 220 upward, and then photographic printing by the thermal head 260 is started. When photographic printing for one color is finished, the drive pulleys 306 are rotated in the reverse direction, to thereby move the clamper 220 downward, and the returning operation in which the lenticular sheet 12 is returned to the photographic printing start position is performed.

In addition, as illustrated in FIG. 8A and FIG. 8B, the printing apparatus 10 is provided with a ribbon detection sensor 330 and a ribbon head-detection sensor 332. In the present embodiment, the ribbon detection sensor 330 is provided in the vicinity of a supply reel 256, and the ribbon head-detection sensor 332 is provided adjacently to the ribbon detection sensor 330.

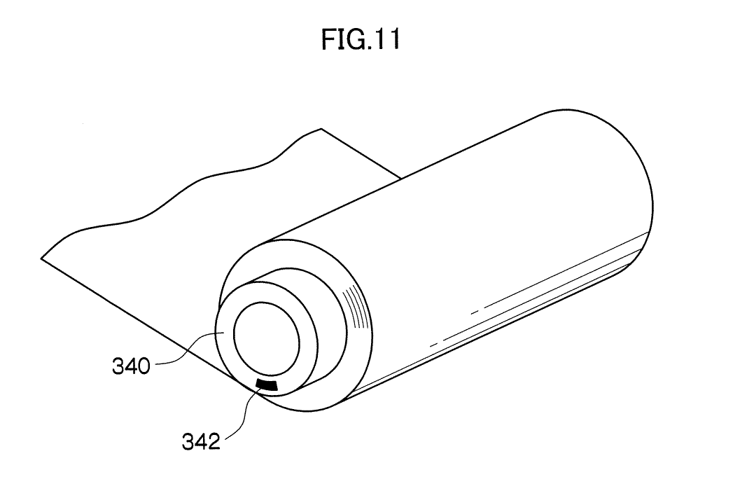

FIG. 11 is a perspective view illustrating an example of an ink ribbon which is loaded onto the supply reel 256. In a winding core (paper tube) 340 of this ink ribbon, a wireless tag 342 which stores therein information of this wound ink ribbon (a type of the ink ribbon, a ribbon width, the color, and the like) is embedded. The ribbon detection sensor 330 is formed of a noncontact wireless tag reader, and thus can read the information of the ink ribbon from the wireless tag 342.

It should be noted that the ribbon detection sensor 330 is not limited to the wireless tag reader, and various sensors can be conceived. For example, if the information of the ink ribbon is recorded as a bar code on the winding core 340 of the ink ribbon, a bar code reader can be adopted.

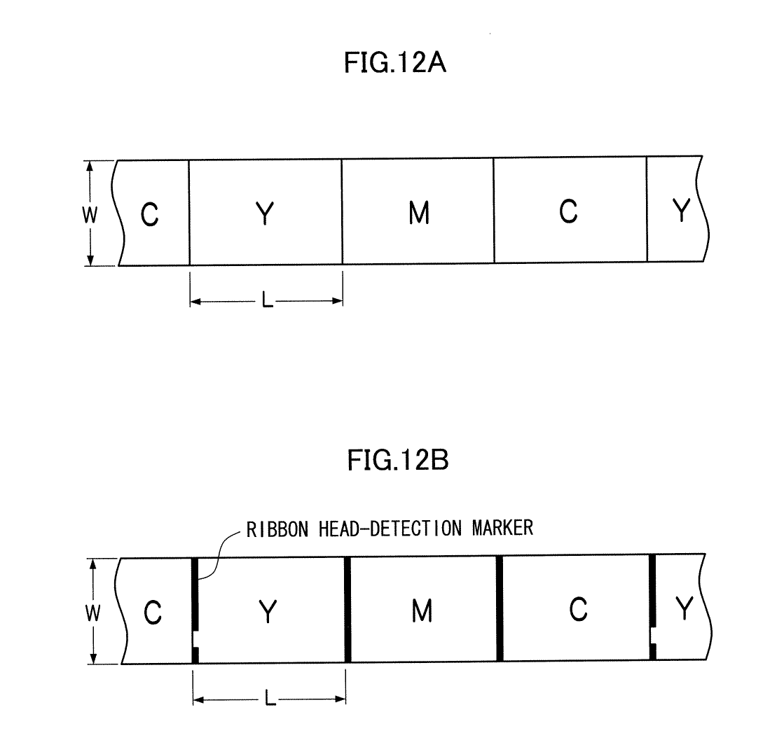

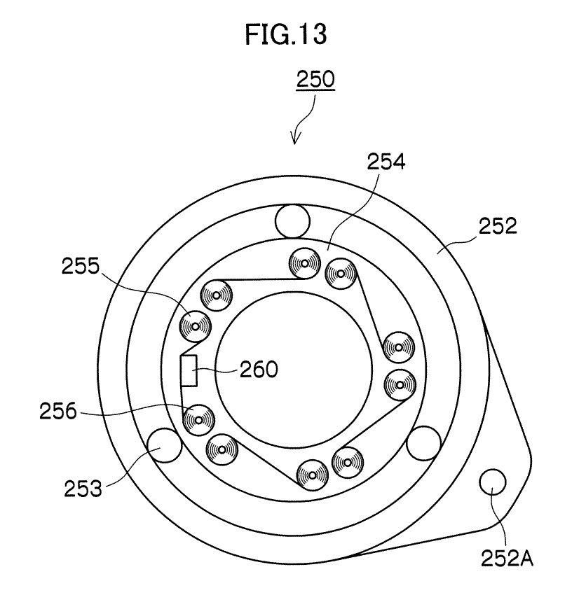

In addition, in the printing apparatus 10, in addition to single-color ink ribbons (single-color ribbons) of Y, M, and C, it is possible to use, as the ink ribbon, a multi-color ink ribbon (multi-color ribbon) to which inks of Y, M, and C each having a predetermined length are sequentially applied as illustrated in FIG. 12A.

In the case where the multi-color ribbon is loaded onto the supply reel 256, the ribbon head-detection sensor 332 can detect a color boundary position between the inks on the multi-color ribbon as well as the color of each ink.

The ribbon head-detection sensor 332 is a reflective photosensor including: an LED which irradiates the multi-color ribbon with white light; and three photosensors having sensitivities in respective wavelength ranges of Y, M, and C. Accordingly, the ribbon head-detection sensor 332 can detect the color of the multi-color ribbon which is opposed to this sensor on the basis of detection outputs of the photosensors, and also can detect the color boundary position between the inks on the basis of a position at which the detected color changes.

It should be noted that the ribbon head-detection sensor 332 is not limited to the sensor in the present embodiment. For example, in the case of using a multi-color ribbon on which a ribbon head-detection marker is provided at the color boundary position between the inks as illustrated in FIG. 12B, a sensor which detects the ribbon head-detection marker may be adopted.

### <Ribbon Switching Rotary Mechanism and Thermal Head>

FIG. 13 is a schematic view illustrating the ribbon switching rotary mechanism 250.

As illustrated in FIG. 13, the ribbon switching rotary mechanism 250 includes a ribbon cage holder 252 and a ribbon cage 254, and the ribbon cage holder 252 can be rocked with respect to a ribbon cage holder rocking shaft 252A.

The thermal head 260 is provided within the ribbon cage holder 252, and is provided at a leading end of an arm member (not illustrated) which is turnably (rotatably) provided on the same axis as the ribbon cage holder rocking shaft 252A. The thermal head 260 can be moved between a photographic printing position and a retreat position by turning the arm member.

The ribbon cage holder 252 can be moved between a photographic printing position and a maintenance position by being rocked (turned) with respect to the ribbon cage holder rocking shaft 252A. In the maintenance position, part of the ribbon cage holder 252 can be protruded from an apparatus main body.

The thermal head 260 moves so as to interlock with the movement of the ribbon cage holder 252 to the maintenance position, and moves to a position at which heater elements of the thermal head 260 can be touched from the outside. As a result, maintenance such as cleaning and replacement of the thermal head 260 can be easily performed.

On the other hand, the ribbon cage 254 is rotatably supported by the ribbon cage holder 252 by means of ribbon cage rotation bearings 253. Five pairs of take-up reels 255 and the supply reels 256 are provided at regular intervals in the ribbon cage 254, and the ink ribbons of R, Y, M, C, and W are set to the five pairs of reels, respectively. The ribbon cage 254 is rotated by the rotary mechanism so that a desired ribbon comes to a position of the thermal head 260.

The information of the type, color, and the like of the ribbons set to the five pairs of reels can be detected by the ribbon detection sensor 330 each time the respective ribbons come to the position of the thermal head 260. Therefore, a rotation position of the ribbon cage 254 is controlled on the basis of a detection signal of the ribbon detection sensor 330, whereby a desired ribbon can be moved to the position of the thermal head 260.

Of a pair of the take-up reel 255 and the supply reel 256 which has been moved to the position of the thermal head 260, the take-up reel 255 takes up the ink ribbon via a friction clutch at a speed slightly higher than a moving speed of the lenticular sheet 12 at the time of photographic printing, and the supply reel 256 is braked so that a predetermined back tension acts on the ink ribbon. With this configuration, when the lenticular sheet 12 is moved at the time of photographic printing, the ink ribbon is fed so as to interlock with (be synchronized with) the movement of the lenticular sheet 12.

The thermal head 260 is moved by a head moving mechanism to the photographic printing position at the time of photographic printing, and is moved thereby to the retreat position at the time of switching of the ink ribbons or reverse feeding of the lenticular sheet 12. At the photographic printing position, the thermal head 260 abuts against the platen roller 262 via the ink ribbon and the lenticular sheet 12. At the retreat position, the thermal head 260 is retreated from the platen roller 262.

In addition, the thermal head 260 is driven in accordance with a multi-view image for a 3D image (in the present embodiment, a six-view image) as described below, and sublimates ink on the ink ribbon to transfer the sublimated ink onto the lenticular sheet 12.

### [Description of Control System of Printing Apparatus]

Next, the control system of the printing apparatus 10 having the above-mentioned configuration is described.

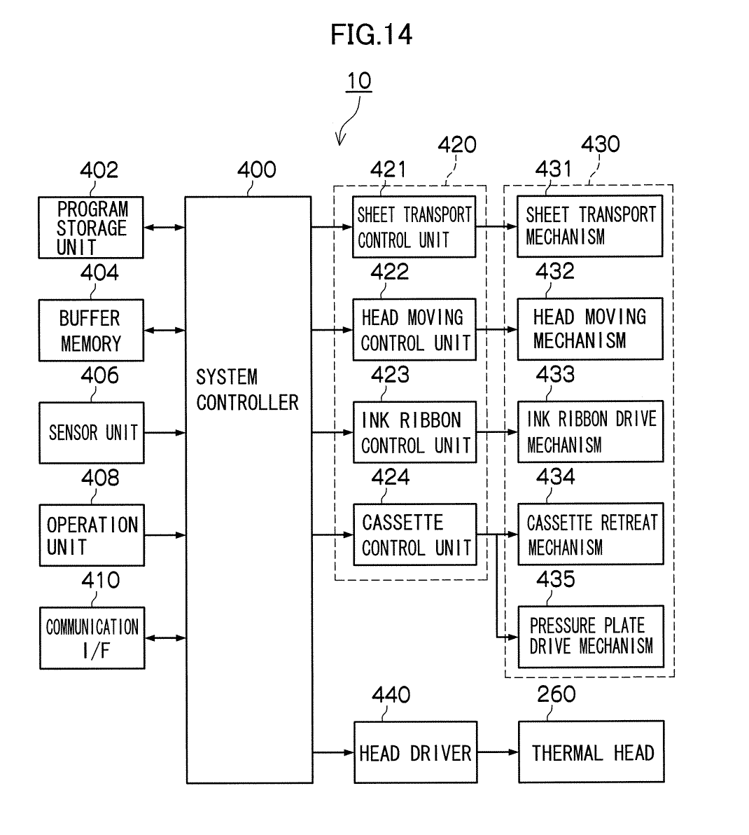

FIG. 14 is a block diagram illustrating a configuration of a main part of the printing apparatus 10.

The printing apparatus 10 includes a system controller 400, a program storage unit 402, a buffer memory 404, a sensor unit 406, an operation unit 408, a communication interface (communication I/F) 410, a control unit 420, a mechanism unit 430, a head driver 440, and the thermal head 260.

The system controller 400 controls the overall units according to a program for 3D printing, and a CPU (central processing unit) and the like can be conceived as the system controller 400. The program storage unit 402 stores therein the program for 3D printing, and the system controller 400 reads out and executes the program stored in the program storage unit 402 as appropriate.

The buffer memory 404 temporarily stores therein photographic print data which is received from a personal computer (PC) (not illustrated) via the communication I/F 410.

The PC connected to the communication I/F 410 acquires a two-view color image (view point images, right and left images) in which the same subject photographed by a 3D camera or the like is photographed, and calculates, for each pixel, a shift amount (shift amount (parallax) between pixels) between feature points at which features match with each other, from the acquired right and left images. The calculated parallax is adjusted so as to suit 3D printing, and then the adjusted parallax is interpolated, to thereby create a six-view image. The PC further converts the color of the six-view image from R, G, and B into Y, M, and C, and generates a Y signal, an M signal, and a C signal for one page from the color-converted six-view image. The Y signal, the M signal, and the C signal are stored as the photographic print data in the buffer memory 404 via the communication I/F 410 from the PC.

It should be noted that the above-mentioned image processing function of the PC may be incorporated in the printing apparatus 10.

The sensor unit 406 includes the photosensors 320A to 320C, the ribbon detection sensor 330, and the ribbon head-detection sensor 332, which are illustrated in FIG. 8A and the like, and sensors which detect positions, rotation angles, and the like in the mechanism unit 430. The sensor unit 406 outputs detection signals which are detected by the respective sensors, to the system controller 400.

The operation unit 408 includes a power switch, a print start switch, and a switch for setting a print page count and the like, and a signal generated by operating the operation unit 408 is inputted to the system controller 400.

The mechanism unit 430 includes the sheet transport mechanism 431, the head moving mechanism 432, an ink ribbon drive mechanism 433, the cassette rocking mechanism 434, and the pressure plate drive mechanism 435.

The sheet transport mechanism 431 includes the feed roller 190, the transport roller 212, the capstan 214, and the clamper 220, which are illustrated in FIG. 1 and the like, and the clamper transport unit 230 (FIG. 10) including the drive motor 302 and the like.

In addition, the control unit 420 includes a sheet transport control unit 421, a head moving control unit 422, an ink ribbon control unit 423, and a cassette control unit 424.

The system controller 400 outputs respective control signals to the control unit 420 in accordance with a photographic printing sequence, and drives and controls the mechanism unit 430 via the control unit 420.

As a result, the sheet transport control unit 420 outputs the lenticular sheet 12 from the sheet feeding cassette 150, and transports the lenticular sheet 12 upward or downward at the time of photographic printing.

As described in FIG. 13, the head moving mechanism 432 turns the arm member having the same turning axis as the ribbon cage holder rocking shaft 252A, to thereby move the thermal head 260 provided at the leading end of the arm member between the photographic printing position at which the thermal head 260 abuts against the platen roller 262 and the retreat position. It should be noted that the retreat position has a small retreat position and a large retreat position. In the case where the ink ribbon is simply fed for ink head-detecting, the thermal head 260 is moved to the small retreat position at which the thermal head 260 is slightly retreated from the platen roller 262. In the case where the ribbon cage 254 is rotated for switching the ink ribbons from one color to another, the thermal head 260 is moved to the large retreat position at which the thermal head 260 does not interfere with the ink ribbon set to the take-up reel 255 and the supply reel 256.

The ink ribbon drive mechanism 433 includes: a mechanism which rotates the ribbon cage 254 of the ribbon switching rotary mechanism 250 illustrated in FIG. 13; and a reel drive mechanism which drives the five pairs of the take-up reels 255 and the supply reels 256 provided in the ribbon cage 254.

As described in FIG. 6, the cassette rocking mechanism 434 includes the plunger 122 and the like, and rocks the sheet storage main body 110 in response to a command from the system controller 400.

As described in FIG. 7, the pressure plate drive mechanism 435 serves to move the pressure plate 112, and thus moves the pressure plate 112 in response to a command from the system controller 400 to apply a given pressing force to the lenticular sheets 12 within the cassette.

A large number of the heater elements are arrayed on the thermal head 260 in a direction orthogonal to the transport direction of the lenticular sheet 12. On the basis of the photographic print data stored in the buffer memory 404, the system controller 400 controls, for each line, temperature of the respective heater elements by means of the head driver 440 so as to obtain a density corresponding to the photographic print data, sublimates ink on the ink ribbon to transfer the sublimated ink onto the lenticular sheet 12, and then causes the sheet transport mechanism 431 to feed the lenticular sheet 12 by one line. The same processing is repeated to sequentially perform thermal transfer from one line to another.

### [Description of Operation of Printing Apparatus]

Next, the operation of the printing apparatus 10 is described.

### <Single-Color Ribbon Sequence>

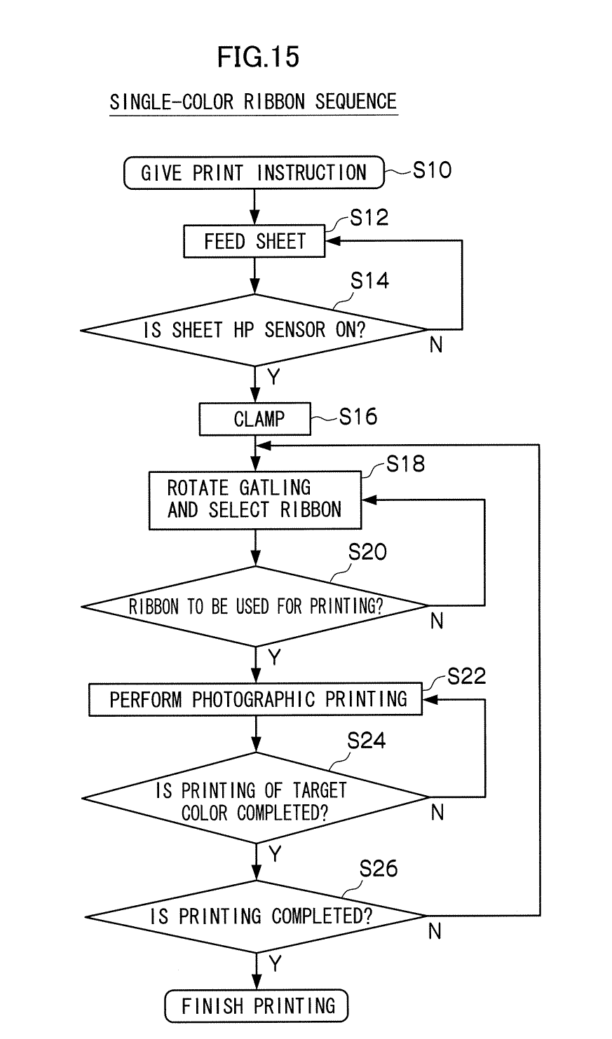

FIG. 15 is a flow chart illustrating a processing operation of the printing apparatus 10 at the time of photographic printing, which is performed using a single-color ribbon. It is assumed that the ribbons of R, Y, M, C, and W are loaded into the ribbon switching rotary mechanism 250.

### [Step S10]

The photographic print data for 3D printing is stored in the buffer memory 404 via the communication I/F 410 from the PC. After that, when the print start switch of the operation unit 408 is turned on, photographic printing is started (Step S10). It should be noted that a print instruction such as photographic printing start may be inputted/outputted from the PC connected to the communication I/F 410.

In addition, at the time of the photographic printing using the single-color ribbon, power is not supplied to the ribbon head-detection sensor 332, and hence the ribbon head-detection sensor 332 is disabled. This makes it possible to extend the lifetime of the ribbon head-detection sensor 332.

### [Steps S12 and S14]

When the print instruction is inputted, first, the system controller 400 causes the feed roller 190 to make one revolution, so that the lenticular sheet 12 is fed from the sheet feeding cassette 150 by a given amount. At this time, the leading end of the lenticular sheet 12 reaches the transport roller 212. Subsequently, the system controller 400 causes the capstan 214 to press against the transport roller 212, so that the lenticular sheet 12 is nipped between the transport roller 212 and the capstan 214. It should be noted that the capstan 214 may be pressed against the transport roller 212 in advance, and the lenticular sheet 12 may be inserted between the transport roller 212 and the capstan 214 at the time of feeding of the lenticular sheet 12 in Step S12.

The system controller 400 drives the transport roller 212, and monitors whether or not the leading end of the lenticular sheet 12 is detected by a sheet home position (HP) sensor (not illustrated) (Step S14). When the sheet leading end is detected by the sheet HP sensor, the system controller 400 stops the transport of the lenticular sheet 12 by the transport roller 212, and causes the lenticular sheet 12 to be transported to the clamper 220. At this time, the clamper 220 stands by at the predetermined lowermost position, and when the sheet HP sensor detects the sheet leading end, the sheet leading end has reached a position at which the sheet leading end can be nipped by the clamper 220.

It should be noted that the system controller 400 drives the transport roller 212 for a given period of time without using the sheet HP sensor, and also in this way, the lenticular sheet 12 can be transported to the clamper 220. In this case, when the leading end of the lenticular sheet 12 abuts against the clamper 220 during the transport for the given period of time, the transport roller 212 is idly rotated. In addition, the lenticular sheet 12 is roughly positioned by bringing the lenticular sheet 12 into abutment against the clamper 220.

### [Step S16]

The system controller 400 drives the cam or the like to close the pair of clamping members by the urging force of the spring, and causes the clamper 220 to nip the lenticular sheet 12. Subsequently, as described in FIG. 10, the azimuth adjustment of the lenticular sheet 12 is performed.

The system controller 400 drives the clamper transport unit 230 to transport the lenticular sheet 12 nipped by the clamper 220 to the photographic printing start position. The photographic printing start position can be set to, for example, a position at which output signals of the photosensors 320A to 320C illustrated in FIG. 8A reach a predetermined value (for example, a peak value) after the transport of the lenticular sheet 12. As a result, a relative position between a lens position of the lenticular sheet 12 and a photographic printing position of the six-view image is adjusted.

### [Steps S18 and S20]

Next, the system controller 400 causes the ribbon switching rotary mechanism 250 into which the ribbons of R, Y, M, C, and W are loaded to rotate, and controls so that a desired ribbon comes to a predetermined photographic printing position, on the basis of the ribbon information detected by the ribbon detection sensor 330 (FIG. 8A). In the present embodiment, the lenticular sheet 12 which does not have R (image receiving layer) is used. Therefore, the ribbon of R is first selected, and then the ribbons of Y, M, C, and W are selected in the stated order.

The ribbon switching rotary mechanism 250 is caused to make one revolution at the time of start-up, the information of the respective ribbons loaded onto the respective reels (supply reels 256) is read by the ribbon detection sensor 330, and then the read information is held in an internal memory. In this way, a desired ribbon can be selected thereafter by controlling the rotation position (reel position) of the ribbon switching rotary mechanism 250.

[Table 1] given below illustrates an example of a table in which the ribbon information is stored correspondingly to reel numbers 1 to 5 of the five supply reels 256.

TABLE 1

| | Photographic Printing |
|---|---|
| | Using Single-Color |
| Reel Number | Ribbon |
| 1 | R (Image Receiving Layer) |
| 2 | Y (Yellow) |
| 3 | M (Magenta) |
| 4 | C (Cyan) |
| 5 | W (White) |

### [Steps S22 and S24]

The system controller 400 causes the clamper 220 to move upward and drives the thermal head 260, to thereby perform photographic printing for one corresponding color. It should be noted that the photographic printing using the ribbons of R and W is photographic printing which is performed over an entire surface of the lenticular sheet 12, whereas the photographic printing using the single-color ribbons of Y, M, and C is photographic printing of color images each corresponding to the photographic print data of Y, M, and C.

### [Step S26]

When the photographic printing for one color is finished, the system controller 400 determines whether or not the photographic printing has been finished for all of the ribbons. In this case, the photographic printing using the ribbon of W is last performed, and hence the system controller 400 determines whether or not the photographic printing using the ribbon of W has been finished.

If the photographic printing of W has not been finished, the system controller 400 returns to Step S18 to perform photographic printing using a ribbon of the next color, and returns (moves downward) the lenticular sheet 12 to the photographic printing start position.

On the other hand, if it is determined that the photographic printing of W has been finished, both ends of the lenticular sheet 12 are cut by a cutter part (not illustrated), and the lenticular sheet 12 is outputted to an outlet port. In this way, a 3D print can be obtained.

### <Multi-Color Ribbon Sequence>

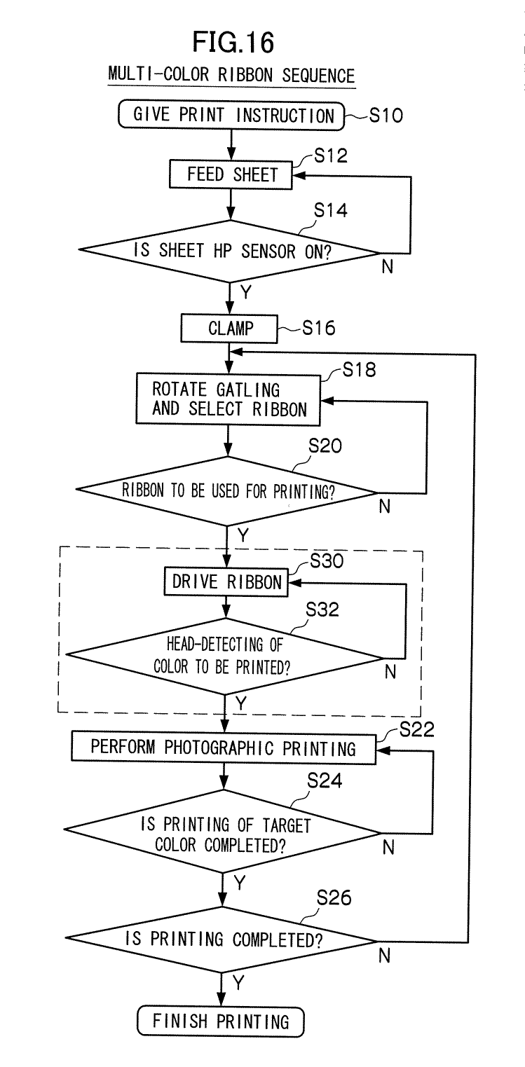

FIG. 16 is a flow chart illustrating a processing operation of the printing apparatus 10 at the time of photographic printing, which is performed using a multi-color ribbon.

It should be noted that the steps common to those at the time of the photographic printing using the single-color ribbon illustrated in FIG. 15 are designated by the same step numbers, and detailed description thereof is omitted. In addition, it is assumed that the ribbon of R, the multi-color ribbon, and the ribbon of W are loaded into the ribbon switching rotary mechanism 250.

As illustrated in FIG. 16, the photographic printing using the multi-color ribbon is different from the photographic printing using the single-color ribbon mainly in that processing of Steps S30 and S32 are added.

### [Steps S30 and S32]

If the multi-color ribbon is selected in Steps S18 and S20, head-detecting of the ink of a desired color on the multi-color ribbon is performed.

The head-detecting of the color to be printed on the multi-color ribbon is performed by moving the thermal head 260 to the small retreat position as illustrated in FIG. 8A and driving the take-up reel 255 to feed the ribbon. That is, after a head position of the ink of a desired color is detected by the ribbon head-detection sensor 332, the ribbon is fed by a predetermined length from the detected position to the position of the thermal head 260, whereby head-detecting of the ribbon is performed.

On the used multi-color ribbon, a length L (see FIG. 12A) of each ink is larger than a length L1 in a sheet feeding direction, of an image to be three-dimensionally printed. Accordingly, the ribbon is idly fed by a length difference ΔL (=L−L1), whereby head-detecting of the ink of the next color can be performed.

Here, in FIG. 8B, a length of the ribbon between the detection position of the ribbon head-detection sensor 332 and the photographic printing position of the thermal head 260 is assumed as La. Further, detected is a feeding amount of the lenticular sheet 12 (which is equal to a ribbon feeding amount) from a time point at which the head position of the ink is detected by the ribbon head-detection sensor 332 until photographic printing for a certain color currently selected is finished, and this ribbon feeding amount is assumed as Lx. In this case, the head position of the ink of the next color on the multi-color ribbon at a time point at which the photographic printing for the certain color is finished is located on the near side (downstream side) with respect to the photographic printing position by ΔL (=La (fixed value)−Lx (detected value)). Accordingly, ΔL described above is obtained, the thermal head 260 is moved to the small retreat position as illustrated in FIG. 8A, and then the multi-color ribbon is idly fed by obtained ΔL, whereby head-detecting of the ink of the next color can be performed.

It should be noted that conceivable methods of obtaining the ribbon feeding amount include: a method of obtaining on the basis of an outer diameter of a ribbon wound around the take-up reel 255 and a rotation amount of the take-up reel 255; and a method of bringing a roller for feeding amount detection into abutment against a ribbon and obtaining on the basis of a rotation amount of the roller.

In addition, ΔL does not necessarily need to be obtained each time. For example, ΔL may be obtained only at the time of head-detecting of the ink of Y, and the ribbon may be fed by a predetermined amount ΔL (=L−L1) at the time of head-detecting of the inks of other colors.

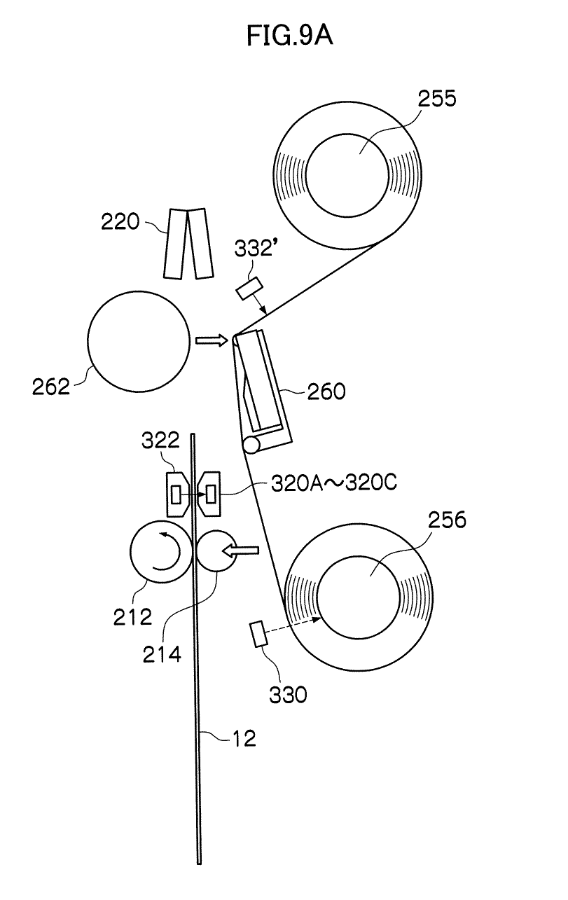

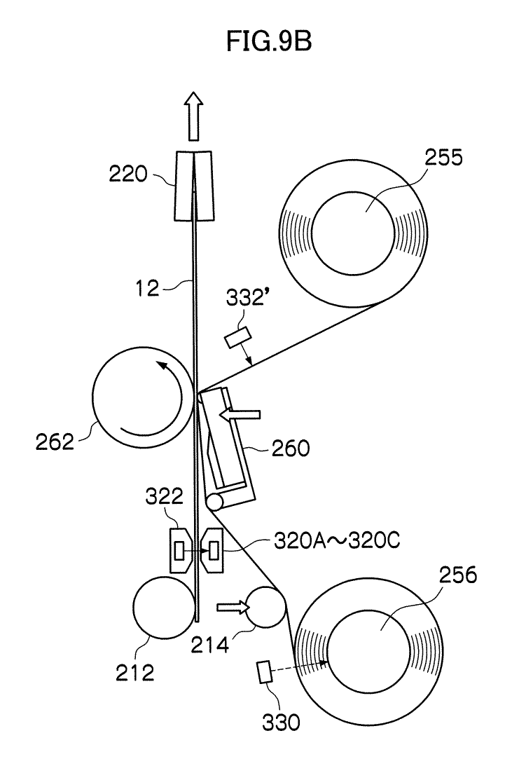

In addition, as illustrated in FIG. 9A and FIG. 9B, a ribbon head-detection sensor 332′ is disposed immediately after the thermal head 260, and the ribbon head-detection marker (FIG. 12B) provided on the multi-color ribbon is detected at the time of feeding of the ribbon, to thereby stop feeding. Also in this way, head-detecting can be performed.

After head-detecting of the multi-color ribbon is performed as described above, the system controller 400 proceeds to Step S22, and photographic printing using the multi-color ribbon (ink) whose head position is detected is performed.

### <Others>

Example 1 in [Table 2] given below illustrates a case where one multi-color ribbon is loaded for photographic printing using the multi-color ribbon, instead of three single-color ribbons of Y, M, and C. In this case, the ribbon switching rotary mechanism 250 has reels onto which a ribbon is not loaded (unused reels).

The ribbon detection sensor 330 can also detect the presence/absence of the ribbon, and hence when a desired ribbon is selected by rotating the ribbon switching rotary mechanism 250, the reels onto which a ribbon is not loaded can be skipped during the rotation.

TABLE 2

| | Photographic Printing Using Multi-color Ribbon | | |
|---|---|---|---|
| Reel Number | Example 1 | Example 2 | Example 3 |
| 1 | R | R | R |
| 2 | Multi-color | Multi-color Ribbon | Multi-color Ribbon A |
| | Ribbon | | |
| 3 | Unused | Multi-color Ribbon | Multi-color Ribbon B |
| 4 | Unused | Multi-color Ribbon | Multi-color Ribbon C |
| 5 | W | W | W |

Example 2 in [Table 2] illustrates a case where three identical multi-color ribbons are loaded instead of the three single-color ribbons. In this case, when it is detected that one of the multi-color ribbons are finished up (consumed), switching is made to another new multi-color ribbon. After all of the three multi-color ribbons are consumed, the three multi-color ribbons can be replaced with new ribbons at the same time.

Alternatively, the three identical multi-color ribbons may be switched in turn for each photographic printing of one page, and the three multi-color ribbons may be evenly used.

Example 3 in [Table 2] illustrates a case where three multi-color ribbons A, B, and C having ribbon widths (a ribbon width W and the ribbon length L illustrated in FIG. 12A) different from each other are loaded instead of the three single-color ribbons.

For example, in the case where photographic printing of lenticular sheets having print sizes of an L size (89 mm×127 mm), a 2L size (127 mm×180 mm), and a one-sixth cut size (203 mm×254 mm) are possible, the multi-color ribbons A, B, and C corresponding to these print sizes are loaded, whereby the multi-color ribbon suitable for each print size can be selected.

That is, when the print size is inputted from the operation unit 408 or the size of the lenticular sheet set to the sheet feeding cassette 150 is detected, the multi-color ribbon corresponding to the print size of the lenticular sheet can be automatically selected.

In addition, in the present embodiment, the lenticular sheet 12 which does not have the R layer (image receiving layer) is used. In the case where a lenticular sheet to which the R layer is applied in advance is used, photographic printing of R becomes unnecessary.

In this case, the multi-color ribbon is loaded instead of the ribbon of R, which makes it possible to load both of the single-color ribbon and the multi-color ribbon into the ribbon switching rotary mechanism 250.

As a result, it is possible to immediately start photographic printing without replacing the ribbons within the ribbon switching rotary mechanism 250, in response to an instruction which is given by a user to perform the photographic printing using the single-color ribbon or the photographic printing using the multi-color ribbon.

It should be noted that five ribbons can be loaded into the ribbon switching rotary mechanism according to the present embodiment, but the presently disclosed subject matter is not limited thereto. In the case of an apparatus which does not perform photographic printing of R (image receiving layer), it is possible to adopt a ribbon switching rotary mechanism into which four ribbons (Y, Y, C, and W) can be loaded. Further, it is also possible to adopt a ribbon switching rotary mechanism into which six or more ribbons can be loaded.

In addition, a multi-color ribbon having W (white) and R (image receiving layer) can be used as the multi-color ribbon. In this case, it is not necessary to rotate the ribbon switching rotary mechanism at the time of the photographic printing using the multi-color ribbon.

Further, in the present embodiment, description is given of the printing apparatus which uses the lenticular sheet to create a 3D print, but the presently disclosed subject matter is not limited thereto. The presently disclosed subject matter can be also applied to an apparatus which performs photographic printing of a 2D color image on a 2D print sheet. In short, the presently disclosed subject matter can be applied to any printing apparatus as long as the printing apparatus transfers ink on a color ink ribbon to a print medium to create a color photographic print.

Still further, the print medium is not limited to a medium (a cut sheet and the like) which is cut into a predetermined size in advance, and may be a rolled medium (a roll sheet and the like).

In addition, it goes without saying that the presently disclosed subject matter is not limited to the above-mentioned embodiment, and thus can be variously modified within a range that does not depart from the spirit of the presently disclosed subject matter.

What is claimed is:

1. A printing apparatus configured to transfer ink on a color ink ribbon to a print medium to thereby create a color photographic print, comprising:
a ribbon switching rotary mechanism into which a plurality of the color ink ribbons are loaded, and the ribbon switching rotary mechanism configured to set a desired one of the color ink ribbons to a photographic printing position;
a ribbon detection device configured to detect the color ink ribbons loaded into the ribbon switching rotary mechanism, the ribbon detection device detecting whether the desired color ink ribbon set to the photographic printing position is a single-color ribbon or a multi-color ribbon;
a ribbon head-detecting device configured to perform head-detecting of the multi-color ribbon in a case where the multi-color ribbon is loaded into the ribbon switching rotary mechanism; and
a control device configured to control the ribbon switching rotary mechanism and the ribbon head-detecting device so as to suit each of a time of photographic printing using the single-color ribbon and a time of photographic printing using the multi-color ribbon.

2. The printing apparatus according to claim 1, wherein:
the ribbon head-detecting device includes:
a ribbon head-detection sensor which detects a color boundary position between respective color ink ribbons of the multi-color ribbon as well as colors of the respective color ink ribbons; and
a ribbon feeding device configured to feed the color ink ribbons loaded into the ribbon switching rotary mechanism; and
the ribbon feeding device is controlled so that head positions of the respective color ink ribbons of the multi-color ribbon come to the photographic printing position, at a start of the photographic printing for each color using the multi-color ribbon on a basis of a detection output of the ribbon head-detection sensor.

3. The printing apparatus according to claim 2, wherein
the ribbon head-detection sensor detects the color of the multi-color ribbon or reads a ribbon head-detection marker which is printed at the color boundary position between the respective color ink ribbons of the multi-color ribbon.

4. The printing apparatus according to claim 1, wherein
the control device stops the ribbon head-detection sensor at the time of the photographic printing using the single-color ribbon.

5. The printing apparatus according to claim 1, further comprising a ribbon presence/absence detection device configured to detect presence/absence of the color ink ribbons loaded into the ribbon switching rotary mechanism, wherein
when the ribbon detection device detects that a plurality of the multi-color ribbons are loaded into the ribbon switching rotary mechanism and when the ribbon presence/absence detection device detects that the multi-color ribbon set to the photographic printing position is finished up, the control device controls the ribbon switching rotary mechanism so that another one of the multi-color ribbons is set to the photographic printing position.

6. The printing apparatus according to claim 1, further comprising an input device through which a print size of the print medium is inputted, wherein:
in a case where the plurality of multi-color ribbons having ribbon widths different from each other are loaded into the ribbon switching rotary mechanism, the ribbon detection device detects the widths of the respective multi-color ribbons; and
in the case where the plurality of multi-color ribbons having the ribbon widths different from each other are loaded into the ribbon switching rotary mechanism, the control device controls the ribbon switching rotary mechanism so that the multi-color ribbon corresponding to the print size inputted through the input device is set to the photographic printing position.

7. The printing apparatus according to claim 1, further comprising a print instruction input device through which a print instruction to perform any one of the photographic printing using the single-color ribbon and the photographic printing using the multi-color ribbon is inputted in a case where the single-color ribbon and the multi-color ribbon are loaded into the ribbon switching rotary mechanism, wherein
the control device controls the ribbon switching rotary mechanism and the ribbon head-detecting device in response to the print instruction inputted through the print instruction input device.

8. The printing apparatus according to claim 1, wherein:
a winding core of the color ink ribbon has attached thereto information indicating whether this color ink ribbon is the single-color ribbon or the multi-color ribbon and, in a case of the single-color ribbon, information indicating a color thereof; and
the ribbon detection device reads the information from the winding core of the color ink ribbon.

9. The printing apparatus according to claim 1, wherein:
the winding core of the color ink ribbon has a wireless tag embedded therein, the wireless tag storing therein the information indicating whether this color ink ribbon is the single-color ribbon or the multi-color ribbon and, in the case of the single-color ribbon, the information indicating the color thereof; and
the ribbon detection device is a wireless tag reader configured to read the information from the wireless tag.

10. The printing apparatus according to claim 1, wherein:
the winding core of the color ink ribbon has, recorded thereon as a bar code, the information indicating whether this color ink ribbon is the single-color ribbon or the multi-color ribbon and, in the case of the single-color ribbon, the information indicating the color thereof; and
the ribbon detection device is a bar code reader configured to read the bar code.

11. The printing apparatus according to claim 1, wherein:
the print medium is a transparent lenticular sheet having a surface on which lenticular lenses are formed;
the printing apparatus transfers an image receiving layer to a rear surface of the lenticular sheet, and then sequentially transfers inks of yellow, magenta, cyan to thereby create the color photographic print for stereoscopic view; and
four or five ribbons can be loaded into the ribbon switching rotary mechanism.
